(19) United States
(12) Patent Application Publication
(10) Pub. No.: US 2022/0134873 A1
(43) Pub. Date: May 5, 2022

(54) MOTOR VEHICLE FLAP SYSTEM

(71) Applicant: Huf Hülsbeck & Fürst GmbH & Co. KG, Velbert (DE)

(72) Inventors: Andreas Beck, Bochum (DE); Mario Muzzetto, Solingen (DE); Anke Rothstein, Wuppertal (DE)

(73) Assignee: Huf Hülsbeck & Fürst GmbH & Co. KG, Velbert (DE)

(21) Appl. No.: 17/435,331

(22) PCT Filed: Nov. 21, 2019
(86) PCT No.: PCT/EP2019/082100

§ 371 Date: Aug. 31, 2021

(30) Foreign Application Priority Data
Mar. 13, 2019 (DE) 10 2019 106 436.8

(51) Int. Cl. B60K 15/05

(52) U.S. Cl. CPC B60K 15/05; B60K 2015/0523

(57) ABSTRACT

The disclosure relates to a motor vehicle flap system, including a lateral wall having an inner side surface, an outer side surface and a through-opening, a flap which is mounted on the inner side surface such that it can move between a closed position closing the through-opening, in which the flap lies within the through-opening and runs perfectly flush with the outer side surface, and an open position releasing the through-opening, and having an actuation lever which is mounted on the inner side surface such that it can swivel between a starting position and an end position, and, with a movement into the end position, the actuation lever is designed to move the flap into the open position, wherein the flap and the actuation lever are swivellably mounted on a guide axis arranged on the inner side surface.

The invention relates to a motor vehicle flap system, comprising a lateral wall having an inner side surface, an outer side surface and a through-opening, a flap which is mounted on the inner side surface such that it can move between a closed position closing the through-opening, in which the flap lies within the through-opening and runs perfectly flush with the outer side surface, and an open position releasing the through-opening, and comprising an actuation lever which is mounted such that it can swivel between a starting position and an end position, and, with a movement into the end position, said actuation lever is designed to move the flap into the open position.

Such a motor vehicle flap system is known, for example, from DE 10 2016 223 010 A1, an actuation lever being provided for swiveling a flap. The actuation lever comprises a first lever arm and a second lever arm which are movably coupled to one another. The first lever arm is driven and swiveled by a drive element, as a result of which the second lever arm also executes a swiveling movement and thereby moves the flap out of a through-opening. The disadvantage in this case is that the flap protruding outward from a lateral wall of the motor vehicle represents an obstacle on which a person can get caught with their clothes, for example. Under specific circumstances, the flap can be bent or even broken off.

The invention is based on the object of providing a motor vehicle flap system of the type mentioned in the introduction, in which the disadvantages mentioned do not occur.

This object is achieved by a motor vehicle flap system, comprising a lateral wall having an inner side surface, an outer side surface and a through-opening, a flap which is mounted on the inner side surface such that it can move on the inner side surface between a closed position closing the through-opening, in which the flap lies within the through-opening and runs perfectly flush with the outer side surface, and an open position releasing the through-opening, and comprising an actuation lever. According to the invention, the flap is thus arranged in the open position on the inner side surface and thus on the inside and does not protrude to the outside as in the prior art. The actuation lever is mounted on the inner side surface such that it can swivel between a starting position and an end position, the actuation lever also being designed to move the flap into the open position during its movement into the end position. Furthermore, the flap and the actuation lever are swivelably mounted on a guide axis arranged on the inner side surface.

Advantageous and expedient embodiments and developments of the invention are disclosed in the dependent claims.

The invention provides a motor vehicle flap system which is characterized by a simple construction and a particular concept for the movement of the flap from a closed position into an open position. According to the invention, the flap is moved under the lateral wall along the inner side surface in the manner of a sliding door and is thus arranged protected from the outside of the lateral wall on the inside of the lateral wall when the flap is moved into its open position. In addition, the actuation lever required for the movement of the flap is also advantageously arranged on the inside of the lateral wall in a protected manner. Because the flap and the actuation lever are swivelably mounted on the guide axis arranged on the inner side surface, the guide axis is used as the only component to support the movement of two components, which not only saves components, but also minimizes the space required.

With a view to further minimizing the installation space and increasing the flexibility of the motor vehicle flap system, the invention provides in an embodiment that the flap is movably mounted in an axial direction along the guide axis. Consequently, the flap cannot only perform a swiveling movement about the guide axis, but the flap can also be moved in a direction toward the actuation lever or away from it and thus out of the through-opening, because the guide axis is oriented perpendicular to the through-opening.

In an embodiment of the invention, it is structurally particularly favorable if a spring element is mounted on the actuation lever or on the flap, which spring element exerts a force on the flap pressing the flap in the direction of the actuation lever. As a result of the spring preload of the spring element, a force acts on the flap which presses the flap in the direction of the actuation lever, which promotes an opening movement of the flap.

The spring preload has a particularly favorable effect if, in an embodiment of the motor vehicle flap system according to the invention, a movement contour is formed on the flap which abuts against a movement attachment formed on the actuation lever. Thus, the spring element presses the movement contour against the movement attachment.

A particularly favorable possibility for realizing a guided movement is, in an embodiment of the invention, that the movement contour has a neutral portion on which the movement attachment abuts in its starting position pressing the flap into its closed position, and an engagement portion, with which the movement attachment engages when the actuation lever is moved in the direction of its end position.

So that the movement of the flap does not take place abruptly, it is further provided in an embodiment of the invention that the engagement portion comprises an entry flank running obliquely from the neutral portion to a base point and a drive flank, and wherein the movement attachment on the drive flank abuts or is designed to press the flap into its open position during a movement of the actuation lever in the direction of its end position.

According to the invention, the actuation lever guides the movement of the flap. For this purpose, it is advantageous in an embodiment of the invention if the movement attachment has an engagement surface which is designed to be complementary to the obliquely running entry flank and rests on the inclined entry flank of the engagement portion when the engagement portion and the movement attachment are in engagement.

To reduce the frictional resistance and undesirable noises during the movement of the movement attachment along the movement contour, the invention provides in an embodiment that the movement attachment rotatably supports a roller element, the movement attachment abutting against the movement contour via the roller element.

The invention further provides that the actuation lever and the flap are designed such that they can jointly swivel about the guide axis when the engagement portion and the movement attachment are in engagement. On the other hand, the flap is decoupled from the actuation lever when there is no engagement between the movement attachment and the engagement portion.

In an embodiment of the invention, the spring preload of the spring element results in the spring element exerting a force pressing the engagement portion onto the movement attachment during a movement of the actuation lever in the direction of its end position.

In order to realize a translational movement of the flap out of the through-opening along the guide axis and thereby prevent a swiveling movement of the flap, it is further provided in an embodiment of the invention that two guide webs are formed on the inner side surface, the flap having a flap lever which is mounted on the guide axis with a first longitudinal end and which carries the flap at a second longitudinal end, the flap lever being arranged horizontally in the closed position of the flap between the two guide webs, and the two guide webs blocking a swiveling movement of the flap lever about the guide axis in the closed position of the flap.

Accordingly, it is advantageous that, in an embodiment of the invention, the flap lever is arranged lying along the guide axis in the direction of the actuation lever outside the two guide webs when the engagement portion and the movement attachment are in engagement.

To support the movement of the flap from the closed position to the open position and back, the invention provides, according to a further embodiment, that a movement guide is formed on the inner side surface, in which a movement pin formed on the flap is arranged in a guided manner.

Should the flap get stuck within the through-opening, which can be the case, for example, in the case of icing or as a result of soiling, the invention offers the possibility of loosening the flap in a further embodiment in that the movement contour has, between the neutral portion and the engagement portion, a deployment portion raised from the neutral portion, wherein the flap is arranged in a deployed position protruding from the through-opening and from the outer side surface, in which the flap is arranged at a greater distance from the actuation lever than in the closed position, and wherein, in the deployed position of the flap, the movement attachment abuts against the deployment portion pressing the flap into the open position. In its opening movement according to this advantageous embodiment, the flap is consequently first moved out of the through-opening before the actual opening movement, directed inward, takes place on the side of the inner side surface.

For an alternative movement guide of the flap, the invention provides in an embodiment that a link guide is formed on the flap, in which a movement pin formed on the actuation lever is arranged, which is designed to press the flap from the closed position into the open position, the link guide being designed to guide a movement of the flap in a direction directed toward the actuation lever and away from the actuation lever. The movement of the flap is thus force-guided, the flap and the actuation lever being coupled to one another at all times.

Finally, it is provided in an embodiment of the invention that a drive element is drivingly connected to the actuation lever and the actuation lever is designed to move from the start position into the end position and back into the starting position. The actuation lever is consequently driven by a motor.

In order to keep the force to be applied by the drive element to move the actuation lever and the flap coupled to the actuation lever low, the invention provides in an embodiment that the drive element drives a drive lever with a drive pin, the actuation lever having an elongated hole in which the drive pin is arranged, and wherein the drive element is drivingly connected to the actuation lever via the drive lever and the drive pin arranged in the elongated hole.

It goes without saying that the features mentioned above and those to be explained below can be used not only in the specified combination but also in other combinations or alone, without departing from the scope of the present invention. The scope of the invention is defined only by the claims.

Other details, features, and advantages of the subject matter of the invention can be found in the following description in conjunction with the drawings, in which an exemplary and preferred embodiment of the invention is shown.

In the drawings:

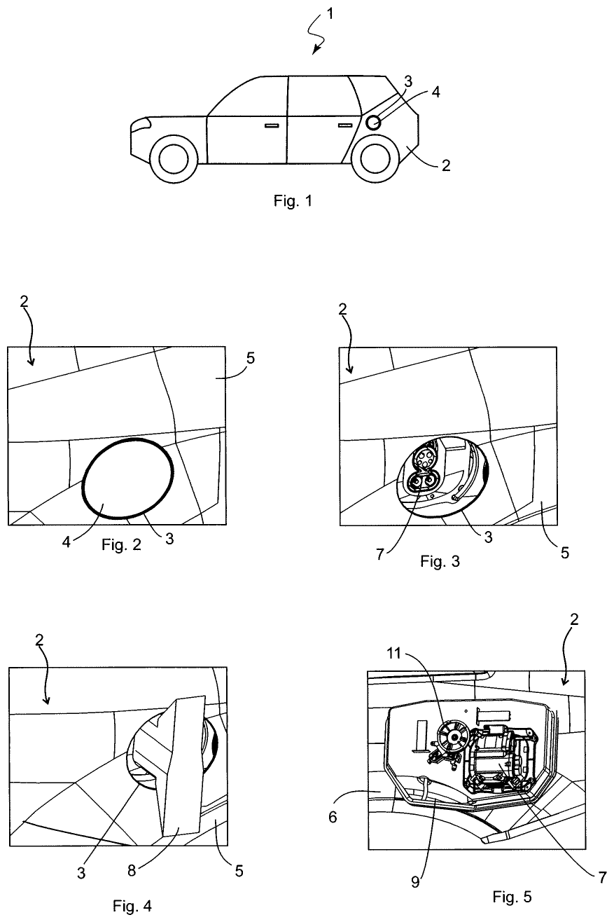

FIG. 1 is a schematic side view of a motor vehicle with a flap closing a through-opening,

FIG. 2 is a perspective view of an outer side surface of a lateral wall of the motor vehicle with the flap arranged in a closed position,

FIG. 3 is a perspective view of the outer side surface of the lateral wall of the motor vehicle with the flap arranged in an open position,

FIG. 4 is a perspective view of the outer side surface of the lateral wall of the motor vehicle with a charging plug inserted through the through-opening,

FIG. 5 is a perspective view of an inner side surface of the lateral wall of the motor vehicle,

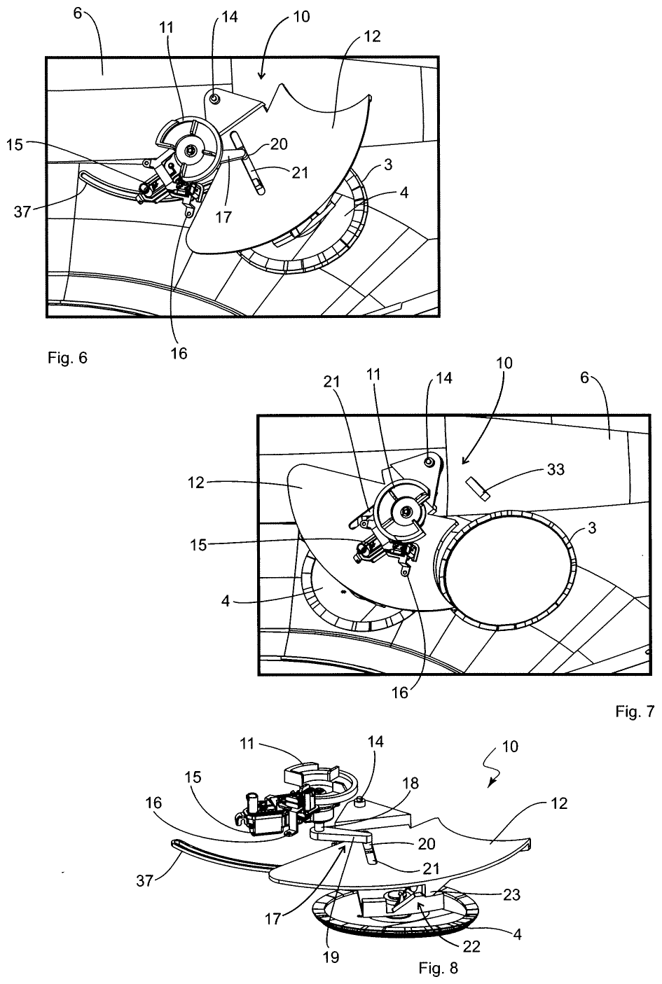

FIG. 6 is an enlarged view of the inner side surface of the lateral wall with the flap arranged in the closed position,

FIG. 7 is an enlarged view of the inner side surface of the lateral wall with the flap arranged in the open position,

FIG. 8 is a perspective view of the motor vehicle flap system without the lateral wall,

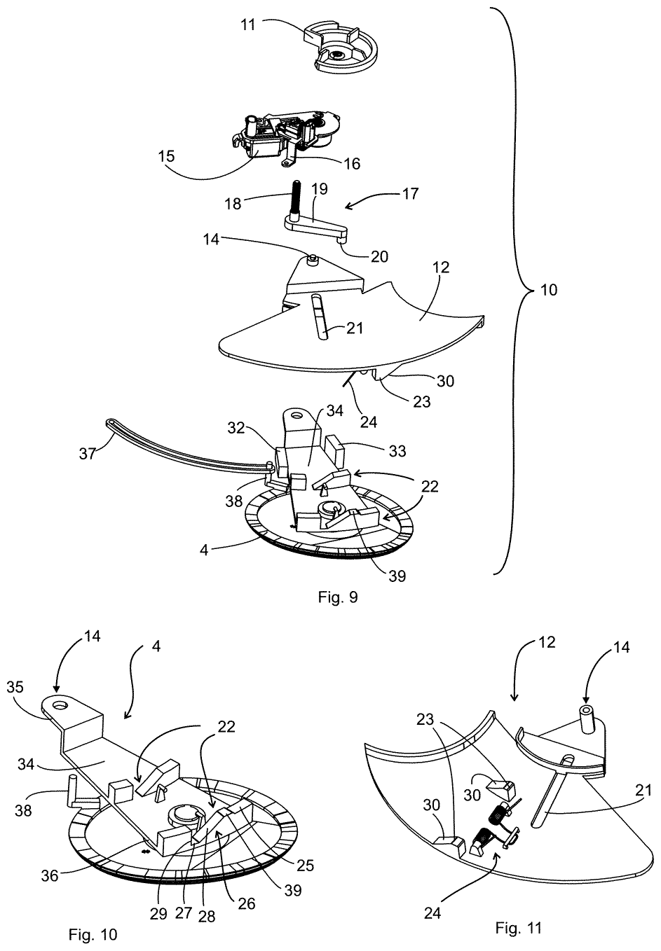

FIG. 9 is a perspective view of the individual parts of the motor vehicle flap system shown in FIG. 8,

FIG. 10 is a perspective view of the flap,

FIG. 11 is a perspective view of an actuation lever of the motor vehicle flap system,

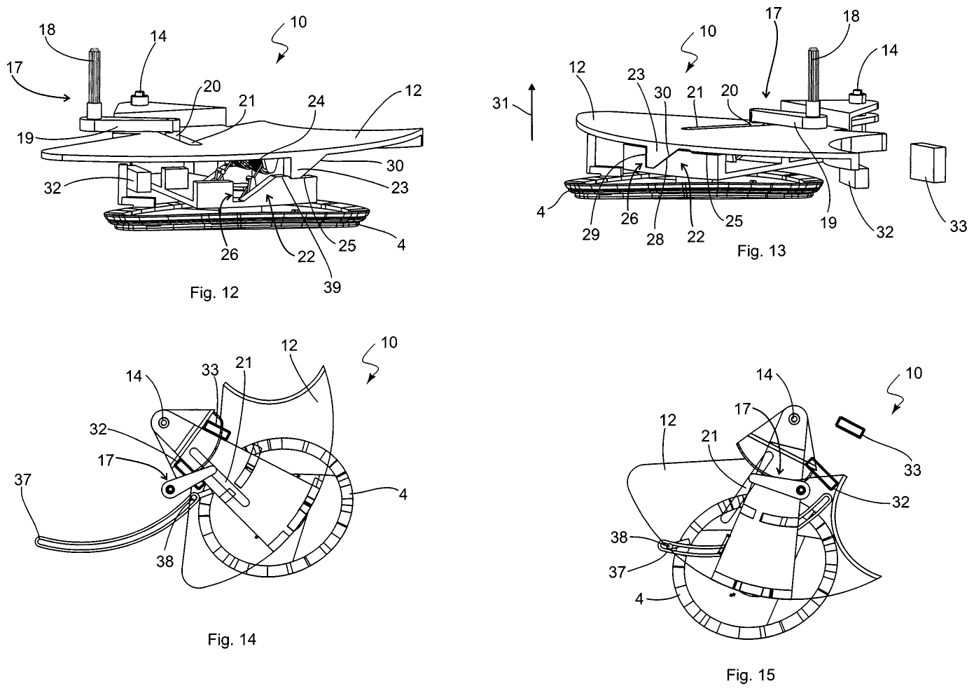

FIG. 12 is a side view of the motor vehicle flap system with the flap arranged in the closed position,

FIG. 13 is a side view of the motor vehicle flap system with the flap arranged in the open position,

FIG. 14 is a plan view of the motor vehicle flap system with the flap arranged in the closed position,

FIG. 15 is a plan view of the motor vehicle flap system with the flap arranged in the open position,

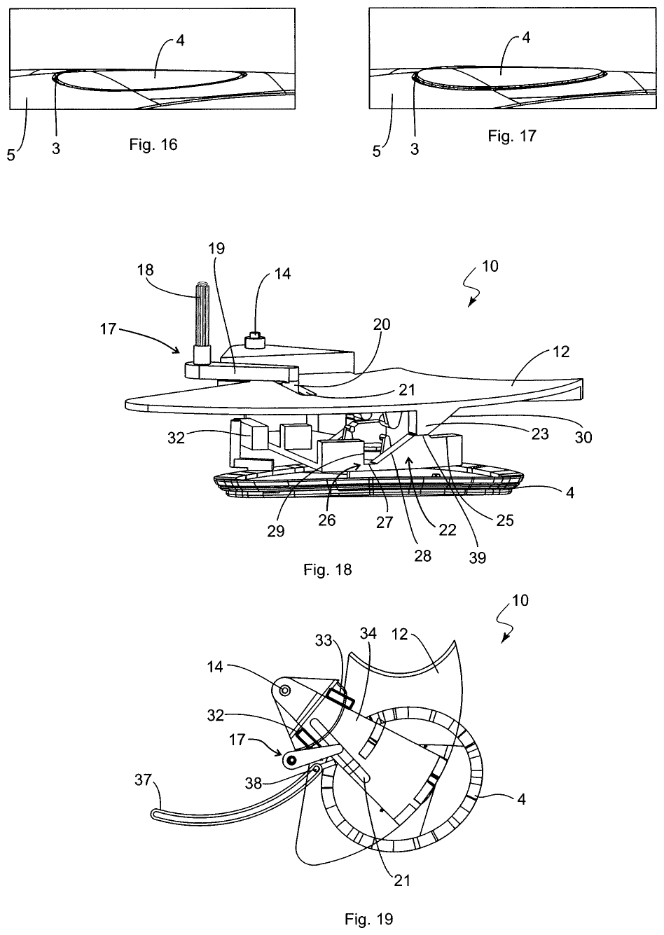

FIG. 16 is a perspective view of the outer side surface of the lateral wall with the flap arranged in the closed position,

FIG. 17 is a perspective view of the outer side surface of the lateral wall with the flap arranged in the open position,

FIG. 18 is a side view of the motor vehicle flap system with the flap arranged in a deployed position,

FIG. 19 is a plan view of the motor vehicle flap system with the flap arranged in the deployed position,

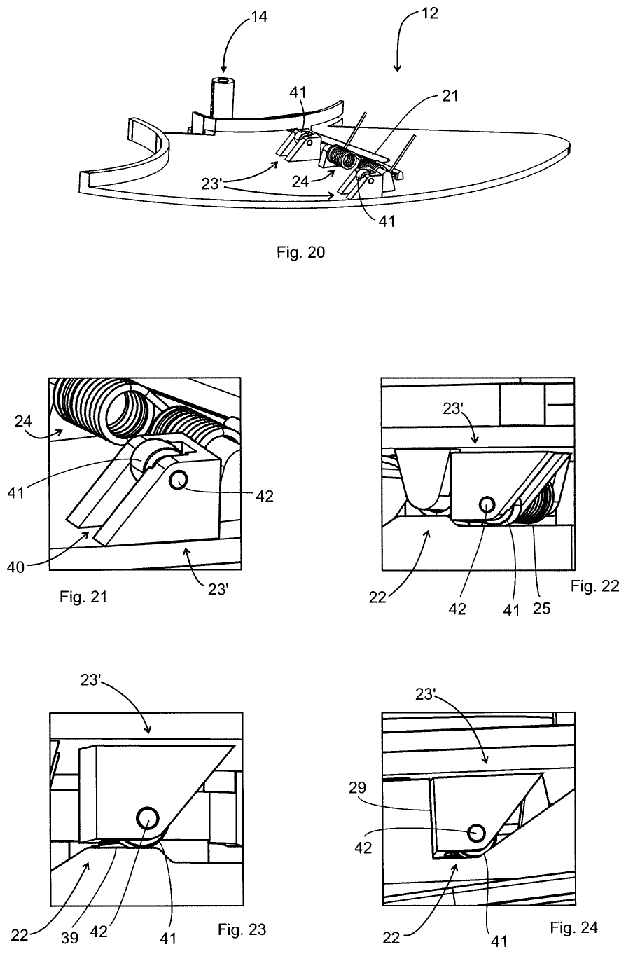

FIG. 20 is a perspective view of particularly designed movement attachments of the actuation lever for the motor vehicle flap system,

FIG. 21 is a detailed view of FIG. 20 of one of the particularly designed movement attachments,

FIG. 22 is a detailed view of the particularly designed movement attachment with the flap arranged in the closed position,

FIG. 23 is a detailed view of the particularly designed movement attachment with the flap arranged in the deployed position, and

FIG. 24 is a detailed view of the particularly designed movement attachment with the flap arranged in the open position.

A motor vehicle 1 is shown in FIG. 1. The motor vehicle 1 has a through-opening 3 in a lateral wall 2 which is closed by a flap 4. The flap 4 can close a fuel filler recess for a conventional vehicle or a charging socket for an electric or hybrid vehicle, whereby it is also conceivable within the meaning of the invention that it is a flap that protects a camera unit in its rest position. The embodiment shown in the drawings is therefore directed only by way of example to a flap that covers a charging socket for an electric or hybrid vehicle. In FIGS. 2 to 4, only the lateral wall 2 of the motor vehicle 1 is shown, an outer side surface 5 of the lateral wall 2 being shown in FIG. 2 and the flap 4 being arranged in a closed position. In the closed position, the flap 4 is arranged within the through-opening 3 and closes the through-opening 3, the flap 4 being arranged to run flush with the outer side surface 5. FIG. 3 also shows the outer side surface 5 of the lateral wall 2 of the motor vehicle 1, the flap 4 now being moved out of the through-opening 3 and being arranged in an open position. In the open position, the flap 4 is mounted on an inner side surface 6 of the lateral wall 2, so that the flap 4 in FIG. 3 is arranged behind the lateral wall 2 and exposes the through-opening 3 so that access is given from the outside through the through-opening 3 to a charging socket 7. This external access can be used to plug a charging plug 8 into the charging socket 7 and to carry out a charging process for a vehicle battery of an electric or hybrid vehicle, as is shown by way of example in FIG. 4. FIG. 5 is a view of the inner side surface 6 of the lateral wall 2 of the motor vehicle 1, wherein a carrier housing 9 can be seen in FIG. 5, which carrier housing is fastened to the inner side surface 6 of the lateral wall 2 and in which the flap 4 is movably arranged. The flap 4 belongs to a motor vehicle flap system 10 according to the invention, the components of which are also housed and mounted within the carrier housing 9 so that they are covered by the carrier housing 9 in FIG. 5 and therefore cannot be seen. FIG. 5 shows the charging socket 7 and a flap emergency actuation lever 11 which can be used in emergency mode to open the flap 4 and which is coupled to the motor vehicle flap system 10 for this purpose.

FIG. 6 is an enlarged view of the inner side surface 6 of the lateral wall 2 of the motor vehicle 1 with the flap 4 arranged in the closed position (the carrier housing 9 not being shown), so that the flap emergency actuation lever 11 and the motor vehicle flap system 10, which will be described in detail below, can be seen. FIG. 7 is likewise an enlarged view of the inner side surface 6 of the lateral wall 2 of the motor vehicle 1, the flap 4 being arranged in the open position and exposing the through-opening 3. The motor vehicle flap system 10 according to the invention is shown in FIG. 8 and in an individual representation in FIG. 9, FIG. 10 showing the flap 4 and FIG. 11 showing an actuation lever 12 of the motor vehicle flap system 10. As can be seen from the synopsis of FIGS. 6 and 7, the flap 4 is mounted on the inner side surface 6 of the lateral wall 2 such that it can move between the closed position (see FIG. 6) and the open position releasing the through-opening 3 (see FIG. 7). The movement of the flap 4 is realized by the actuation lever 12, the actuation lever 12 for this purpose being mounted on the inner side surface 6 such that it can swivel between a starting position (see FIGS. 6, 12 and 14), in which the flap 4 is arranged in the closed position, and an end position (see FIGS. 7, 13 and 15), in which the flap is arranged in the open position. During its movement into the end position, the actuation lever 12 moves the flap 4 into the open position, the structural details of the design being discussed below.

Looking at FIGS. 6 to 15 together, it can be seen that the motor vehicle flap system 10 has a guide axis 14 which is arranged on the inner side surface 6. The guide axis 14 can be attached directly to the inner side surface 6. In any case, the guide axis 14 is covered by the carrier housing 9. Both the actuation lever 12 and the flap 4 are swivelably mounted on the guide axis 14, the flap 4 being arranged between the actuation lever 12 and the inner side surface 6 of the lateral wall 2 when the flap 4 is arranged outside the through-opening 3 of the lateral wall 2. A drive element 15 is fastened to the inner side surface 6 of the lateral wall 2 via a carrier 16. The drive element 15 is drivingly connected to the actuation lever 12, the drive connection being established by a drive lever 17 which connects the drive element 15 to the actuation lever 12. More precisely, the drive lever 17 has a drive shaft 18 which is driven to rotate by the drive element 15, a lever arm 19 protruding from the drive shaft 18, as can be seen from FIG. 9. The lever arm 19 has a free end 20 on which a drive pin 20 is formed. This drive pin 20 is arranged in an elongated hole 21 which is formed in the actuation lever 12. When the drive element 15 now drives the drive lever 17, the drive pin 20 presses against the edge of the elongated hole 21 and thereby swivels the actuation lever 12 about the guide axis 14. Consequently, the drive element 15 is drivingly connected to the actuation lever 12 via the drive lever 17 and the drive pin 20 arranged in the elongated hole 21 (see for example FIG. 8), so that the drive element 15 can move the actuation lever 12 from the start position into the end position and back into the starting position, whereby the actuation lever 12 swivels about the guide axis 14 during this movement.

So that the actuation lever 12 can move the flap 4 into the open position during its movement in the direction of the end position, a movement contour 22 is formed on the flap 4 and abuts against a movement attachment 23 formed on the actuation lever 12. A spring element 24 (see, for example, FIG. 11), which is mounted on the actuation lever 12 in the embodiment shown, wherein the spring element could alternatively also be mounted on the flap 4, is responsible for the interaction. It is only important that the spring element 24 exerts a force on the flap 4 pressing the flap 4 in the direction of the actuation lever 12, so that the spring element 24 presses the movement contour 22 permanently against the movement attachment 23 formed on the actuation lever 12 and the movement contour 22 abuts against the movement attachment 23. As shown in FIGS. 9 to 11 in particular, two movement attachments 23 are provided in the embodiment shown, which are arranged and formed on different radii with respect to the guide axis 14, the position of the guide axis 14 being indicated by the arrow in FIG. 11. The same is true for the movement contour 22, which is formed and arranged in a pair on the flap 4 but on different radii with respect to the guide axis 14. The respective radial distances for the movement contours 22 and the movement attachments 23 are identical in order to be able to fulfill the above-described arrangement of the movement contours 22 resting on the movement attachments 23 and pressing against them. Each movement contour 22 has a neutral portion 25 and an engagement portion 26, the movement attachment 23 in its starting position abutting against the neutral portion 25 and pressing the flap 4 into its closed position, as shown in FIGS. 12 and 14, FIG. 14 showing the actuation lever 12 transparently in order to make it possible to recognize the flap 4 arranged underneath. In the case of the engagement portion 26 of each movement contour 22, the associated movement attachments 23 are in engagement during the movement of the actuation lever 12 in the direction of its end position, which is shown in FIGS. 13 and 15, in which the actuation lever 12 is arranged in its end position and the flap 4 in its open position, FIG. 15 also showing the actuating lever 12 transparently in order to make it possible to recognize the flap 4 arranged underneath. It goes without saying that, instead of two movement contours 22 and two movement attachments 23, only a single movement contour 22 and a single movement attachment 23 can be provided. The engagement portion 26 is designed to be trapezoidal and comprises an entry flank 28 running obliquely from the neutral portion 25 to a base point 27, and a drive flank 29, as can be seen from FIG. 10, for example. Correspondingly, when the actuation lever 12 is moved in the direction of its end position, the movement attachment 23 on the drive flank 29 is designed to press the flap 4 into its open position, as can be seen, for example, from FIG. 13. For this purpose, the movement attachment 23 is also designed to be trapezoidal and has an engagement surface 30 which is designed to be complementary to the obliquely running entry flank 28 and rests on the inclined entry flank 28 of the engagement portion 26 when the engagement portion 26 and the movement attachment 23 are in engagement. As a result of the force of the spring element 24, the engagement portion 26 is pressed onto the movement attachment 23 when the drive element 15 moves the actuation lever 12 from the starting position into the end position, the flap 4 then moving along the guide axis 14 in an axial direction 31 (see, for example, FIG. 13) so that the flap 4 moves out of the through-opening 3 and in the direction of the actuation lever 12 as a result of the force of the spring element 24. The flap 4 is thus mounted such that it can move along the guide axis 14 in the axial direction 31, the flap 4 also being mounted such that it can swivel about the guide axis 14. The guide axis 14 is aligned perpendicular to the through-opening 3. When the engagement portion 26 and the movement attachment 23 are in engagement, the actuation lever 12 and the flap 4 swivel together about the guide axis 14. The spring element 24 exerts a force pressing the engagement portion 26 onto the movement attachment 23′ during a movement of the actuation lever 12 in the direction of its end position (see, for example, FIG. 13). On the other hand, the flap 4 is decoupled from the actuation lever 12 when there is no engagement between the movement attachment 23 and the engagement portion 26.

In order to avoid damage to the through-opening 3, it is provided according to the invention that the flap 4 can only move along the guide axis 14 in the axial direction 31 during its movement out of the closed position. For this purpose, two guide webs 32 and 33 are formed on the inner side surface 6. Furthermore, the flap 4 has a flap lever 34 which can be formed in one piece with the flap 4. The flap lever 34 is mounted with a first longitudinal end 35 on the guide axis 14, so that consequently the flap 4 is swivelably mounted on the guide axis 14 via the flap lever 34. At a second longitudinal end 36, the flap lever 34 then carries the flap 4 with which the through-opening 3 can be closed. In the closed position of the flap 4, the flap lever 34 is arranged lying between the two guide webs 32, 33 (see, for example, FIG. 14), the two guide webs 32, 33 blocking a swiveling movement of the flap lever 34 about the guide axis 14 in the closed position of the flap 4. As can also be seen from FIG. 14, the flap lever 34 is arranged lying along the guide axis 14 in the direction of the actuation lever 12 outside the two guide webs 32, 33 when the engagement portion 26 and the movement attachment 23 are in engagement. FIGS. 14 and 15 also show that a movement guide 37 having an elongated hole is formed on the inner side surface 6 in which a movement pin 38 formed on the flap 4 is arranged in a guided manner.

With reference to FIGS. 12 to 15, the mode of operation of the motor vehicle flap system 10 according to the invention is described below. In FIGS. 12 and 14, the flap 4 is arranged in the closed position, whereas the actuation lever 12 is arranged in its starting position. In this arrangement, the spring element 24 presses the neutral portion 25 against the movement attachment 23, so that the flap 4 is arranged lying in the through-opening 3 and closes it. If the drive element 15 is now put into operation in order to clear the through-opening 3, the drive element 15 moves the drive lever 17, which in turn is drivingly connected to the actuation lever 12 via its drive pin 20. The drive element 15 thus swivels the actuation lever 12 about the guide axis 14 via the drive lever 17, so that the movement attachment 23 slides along the neutral portion 25 of the flap 4 in the direction of the engagement portion 26. When the movement attachment 23 has reached the engagement portion 26, the spring element 24 presses the flap 4 in the direction of the actuation lever 12, the flap 4 only being able to move in the axial direction 31 along the guide axis 14 due to the guide webs 32, 33. In this case, the spring element 24 presses the engagement portion 26 onto the movement attachment 23, the flap 4 then also being arranged after its axial movement along the guide axis 14 outside the guide webs 32, 33 and swiveling with the actuation lever 12 about the guide axis 14 because the engagement portion 26 is in engagement with the movement attachment 23. Accordingly, the actuation lever 12 then moves the flap 4 with it until the actuation lever 12 is arranged in its end position in which the flap 4 is arranged in its open position, as shown in FIGS. 13 and 15. The through-opening 3 is then closed in the reverse order, the actuation lever 12 moving the flap 4 along in the direction of the closed position until the flap lever 34 abuts against the guide web 33. From then on, the movement attachment 23 presses the flap 4 in the direction of the through-opening 3 along the guide axis 14, in that the actuation lever 12 pivots further about the guide axis 14 and thereby moves the movement attachment 23 along the entry flank 28 to the neutral portion 25. Because the flap lever 34 abuts against the guide web 33, the movement attachment 23 of the actuation lever 12 slides along the movement contour 22 of the flap 4.

FIGS. 16 to 19 show an expansion for the motor vehicle flap system 10 described above. This expansion is a functionality for a case in which the force of the spring element 24 would not be sufficient to move the flap 4 from its closed position along the guide axis 14 in the direction of the actuation lever 12. Such a case can exist, for example, when the flap 4 does not move out of the closed position due to icing in winter. In order to break loose the flap 4 or to get it movable again, the movement contour 22 has a deployment portion 39 extending from the neutral portion 25 in the direction of the actuation lever 12 between the neutral portion 25 and the engagement portion 26 (see, for example, FIG. 18). When the movement attachment 23 moves along the movement contour 22, this deployment portion 39 ensures that the flap 4 is arranged in a deployed position protruding from the through-opening 3 and from the outer side surface 5. The deployed position is shown in FIGS. 17 to 19, the flap 4 being arranged at a greater distance from the actuation lever 12 in the deployed position than in the closed position shown in FIG. 16. In the deployed position of the flap 4, due to the force of the spring element 24, the movement attachment 23 abuts against the deployment portion 39, so that the movement attachment 23 presses the flap 4 into the open position.

FIGS. 20 to 24 show a particular embodiment of the movement attachments 23′ of the actuation lever 12. As FIGS. 20 and 21 show, the movement attachments 23′ each have a central recess 40 according to this particular embodiment. The slot-shaped recesses 40 of the two movement attachments 23′ are dimensioned such that the respective slot-shaped recess 40 receives a roller element 41 which is rotatably mounted on the corresponding movement attachment 23′ via a bearing axis 42. The respective roller element 41 protrudes in portions from the recess 40 in such a way that each movement attachment 23′ abuts against the movement contour 22 of the flap 4 via the roller element 41. The roller elements 41 reduce the frictional resistance and undesired noises when the movement attachments 23′ move relative to the corresponding movement contours 22 of the flap 4. In FIGS. 22 to 24, different arrangements of one of the two roller elements 41 on the movement contour 22 are shown. In FIG. 22, the flap 4 is arranged in its closed position, the movement attachment 23′ shown abutting against the neutral portion 25 of the movement contour 22 via the roller element 41. In FIG. 23, the flap 4 is arranged in its deployed position, in which the movement attachment 23′ then abuts against the deployment portion 39 of the movement contour 22 via the roller element 41. Finally, in FIG. 24, the flap 4 is arranged in its open position. In the open position of the flap 4, the movement attachment 23′ abuts against the drive flank 29.

As an alternative to the movement mechanics described above, a link guide can be formed on the flap 4 for a different embodiment of a motor vehicle flap system, in which a movement pin formed on the actuation lever 12 is arranged, which is designed to press the flap 4 from the closed position into the open position. In this case, the link guide can be designed to guide a movement of the flap 4 in a direction directed toward the actuation lever 12 and away from the actuation lever 12. In this way, the flap 4 would be force-guided and permanently coupled to the actuation lever 12, but it is possible to dispense with a spring element in order to move the flap 4 out of the through-opening 3.

Of course, the invention described above is not limited to the described and illustrated embodiment. It can be seen that numerous modifications can be made to the embodiment depicted in the drawing, which are obvious to a person skilled in the art according to the intended application, without leaving the scope of the invention. The invention includes everything that is contained in the description and/or shown in the drawing, including anything that, deviating from the specific embodiment, is obvious to a person skilled in the art.

1. A motor vehicle flap system, comprising a lateral wall having an inner side surface, an outer side surface and a through-opening, a flap which is mounted on the inner side surface such that it can move between a closed position closing the through-opening, in which the flap lies within the through-opening and runs perfectly flush with the outer side surface, and an open position releasing the through-opening, and an actuation lever which is mounted on the inner side surface such that it can swivel between a starting position and an end position, and, with a movement into the end position, said actuation lever is designed to move the flap into the open position, wherein the flap and the actuation lever are swivellably mounted on a guide axis arranged on the inner side surface.

2. A motor vehicle flap system according to claim 1, wherein the flap is movably mounted in an axial direction along the guide axis.

3. A motor vehicle flap system according to claim 2, wherein a spring element is mounted on the actuation lever or on the flap, which spring element exerts a force on the flap pressing the flap in the direction of the actuation lever.

4. A motor vehicle flap system according to claim 3, wherein a movement contour is formed on the flap and abuts against a movement attachment formed on the actuation lever.

5. A motor vehicle flap system according to claim 4, wherein the movement contour has a neutral portion on which the movement attachment abuts in its starting position pressing the flap into its closed position, and an engagement portion, with which the movement attachment engages when the actuation lever is moved in the direction of its end position.

6. A motor vehicle flap system according to claim 5, wherein the engagement portion comprises an entry flank running obliquely from the neutral portion to a base point and a drive flank, and wherein the movement attachment on the drive flank is designed to press the flap into its open position during a movement of the actuation lever in the direction of its end position.

7. A motor vehicle flap system according to claim 6, wherein the movement attachment has an engagement surface which is designed to be complementary to the obliquely running entry flank and rests on the inclined entry flank of the engagement portion when the engagement portion and the movement attachment are in engagement.

8. A motor vehicle flap system according to claim 4, wherein the movement attachment rotatably supports a roller element, and wherein the movement attachment abuts against the movement contour via the roller element.

9. A motor vehicle flap system according to claim 5, wherein the actuation lever and the flap are designed such that they can jointly swivel about the guide axis when the engagement portion and the movement attachment are in engagement.

10. A motor vehicle flap system according to claim 5, wherein the spring element exerts a force pressing the engagement portion onto the movement attachment during a movement of the actuation lever in the direction of its end position.

11. A motor vehicle flap system according to claim 5, characterized in that wherein two guide webs are formed on the inner side surface, the flap having a flap lever which is mounted on the guide axis with a first longitudinal end and which carries the flap at a second longitudinal end, the flap lever being arranged horizontally in the closed position of the flap between the two guide webs, and the two guide webs blocking a swiveling movement of the flap lever about the guide axis in the closed position of the flap.

12. A motor vehicle flap system according to claim 11, wherein the flap lever is arranged lying along the guide axis in the direction of the actuation lever outside the two guide webs when the engagement portion and the movement attachment are in engagement.

13. A motor vehicle flap system according to claim 1, wherein a movement guide is formed on the inner side surface in which a movement pin formed on the flap is arranged in a guided manner.

14. A motor vehicle flap system according to claim 5, wherein, between the neutral portion and the engagement portion, the movement contour has a deployment portion rising from the neutral portion, wherein the flap is arranged in a deployed position protruding from the through-opening and from the outer side surface, in which the flap is arranged at a greater distance from the actuation lever than in the closed position, and wherein, in the deployed position of the flap, the movement attachment abuts against the deployment portion pressing the flap into the open position.

15. A motor vehicle flap system according to claim 1, wherein a link guide is formed on the flap, in which a movement pin formed on the actuation lever is arranged, which is designed to press the flap from the closed position into the open position, the link guide being designed to guide a movement of the flap in a direction directed toward the actuation lever and away from the actuation lever.

16. A motor vehicle flap system according to claim 1, wherein a drive element is drivingly connected to the actuation lever and the actuation lever is designed to move from the start position into the end position and back into the starting position.

17. A motor vehicle flap system according to claim 16, wherein the drive element drives a drive lever with a drive pin, the actuation lever having an elongated hole in which the drive pin is arranged, and wherein the drive element is drivingly connected to the actuation lever via the drive lever and the drive pin arranged in the elongated hole.
